(19) United States
(12) Patent Application Publication
(10) Pub. No.: US 2005/0142261 A1
(43) Pub. Date: Jun. 30, 2005

(54) Baking system and method for on demand baking of food products

(76) Inventor: Mui Lin Cheong, Lakewood, CO (US)

Correspondence Address: Mui Lin Cheong, 980 South Upham Street, Lakewood, CO, 80226, US

(21) Appl. No.: 10/947,118

(22) Filed: Sep. 22, 2004

Related U.S. Application Data
(60) Provisional application No. 60/504,856, filed on Sep. 22, 2003.

(51) Int. Cl. C12C 3/04

(52) U.S. Cl. 426/392

(57) ABSTRACT

Baking systems and methods for on demand baking of food products such as bread and bread-type food products. Food products are partially baked and frozen. For delivering to a customer on demand, the partially-baked frozen food products are partially thawed and then baked in an air impingement oven, or they can be baked in a microwave air impingement oven without the need for partial thawing. The baked food products are packaged, such as in tissue, and delivered to a customer. The final baking for delivery to a customer in the systems and methods only takes minutes so that customers can be provided with freshly baked food products on demand, eliminating the need to waste food baked ahead of time.

### REFERENCE TO RELATED APPLICATION

The present application is related to, and claims priority to, U.S. Provisional Patent Application Ser. No. 60/504,856, entitled “Baking System,” and filed Sep. 22, 2003, which is incorporated herein by reference.

### FIELD OF THE INVENTION

The present invention relates to a method and system for on demand baking of food products.

### BACKGROUND OF THE INVENTION

Certain food products such as bread-type food products are typically baked at least every day in particular retail establishments so that customers have freshly baked food products. In particular, the industry trend is heading towards “hot and fresh” as seen by the rise of quick casual restaurants such as the QDOBA, QUIZNO'S, PAPA MURPHY'S, and KRISPY KREME restaurants. Supermarkets are also joining into this “hot” trend by offering a few bake off times during the day for bread. They know that hot is perceived as freshly baked, and this perception is important to the customer. Also, in the case of bread, certain establishments such as bakeries or grocery stores prefer to bake bread daily or throughout the day so that they often have the aroma of baking bread, which may entice customers to buy bread or bread-type food products.

In order to satisfy this trend, most bakers or restaurateurs would either bake bread from scratch or from a frozen state with conduction deck ovens. This process requires a long time to bake, about twenty minutes, typically much longer than customers are willing to wait. Also, if these establishments do not sell all of the bread-type food products baked each day, which often happens, then they must discard the unsold food products and bake new ones the next day. This situation thus can result in a tremendous amount of wasted food products, affecting the revenue for the establishments.

Accordingly, a need exists for an improved method and system for baking bread-type and other food products on demand.

### SUMMARY OF THE INVENTION

Methods consistent with the present invention provides for on demand baking of a food product. In one aspect of the methods, a partially-baked frozen food product is partially thawed and then baked in an air impingement oven. In another aspect, the partially-baked frozen food product is baked in a microwave air impingement oven without the need for partial thawing. The baked food product is packaged and delivered on demand to a customer, for example, in a relatively short amount of time.

Baking systems consistent with the present invention can be used for on demand baking of food products. The systems include a frozen storage for maintaining a partially-baked food product in frozen state. One aspect of the systems also includes a dry storage for partially thawing the partially-baked food product and an air impingement oven for baking the partially-thawed partially-baked food product. In another aspect, the partially-baked frozen food product is baked in a microwave air impingement oven without the need for partial thawing. The systems can also include packaging for delivering on demand the baked food product to a customer, for example, in a relatively short amount of time.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a baking system for on demand baking of food products;

FIG. 2 is a flow chart of a first method for on demand baking of food products; and

FIG. 3 is a flow chart of a second method for on demand baking of food products.

### DETAILED DESCRIPTION

### Overview

One process, consistent with the present invention, can bake bread in ten minutes or more quickly after the customer orders. The process starts at the frozen storage of at least 80% baked bread in a freezer. Bread is stored in boxes, for example, at this stage in a frozen state, at less than 32° Fahrenheit (F.), until needed. In the morning, for example, the bread is thawed at room temperature (approximately 70° F.) for a minimum of one hour in a covered storage container such as on wire shelves. Upon demand when ordered by a customer, the bread is placed into the oven. The oven, a conveyor type, air impingement oven, in one embodiment, with a sufficiently high clearance bakes that bread at 450° F. Long loafs finish baking in about eight minutes, while round loafs take ten minutes in this embodiment. After baking, the bread is wrapped using tissue, for example, in order to let the hot bread breathe well, and it is delivered or given to the customer.

Another process, consistent with the present invention, does not require partial thawing of the partially-baked bread or bread-type food products. Rather, the partially-baked and frozen bread or bread-type food products are placed directly in a microwave air impingement oven and baking is finished in that oven. The food products can then be wrapped in tissue, for example, and given to a customer. The microwave air impingement oven uses both microwaves energy and forced heated air to simultaneously thaw and bake food products.

The term “food product” includes any type of food requiring baking or cooking for consumption. The term “bread-type food product” includes any type of food having a bread-like component and requiring baking or cooking for consumption. Examples of bread-type food products include, but are not limited to, the following: long bread loaves; round bread loaves; cookies; muffins; cake; pastries; pies; and pizza.

These processes address difficulties inherent in quickly baking bread or bread-type food products. In particular, bread, having a high composition of carbohydrates, has heat insulation properties, meaning it is difficult to heat up or, when heated up, holds the heat in well. Therefore, bread, unlike other entrees has completely different heat transfer rates and takes a longer time to bake. Having this knowledge, it is determined that the air impingement technology, at this time, provides the most effective rates of heat transfer in bread, and therefore the ability to bake bread at a very rapid rate. Finishing baking of bread in an air impingement oven is unheard of in this industry and thus would not be used by most traditional bakers.

The benefits of these exemplary processes include at least the following. Customers receive freshly baked hot bread or bread-type food products at their demand. Owners of systems to implement these processes will not need to discard any bread or bread-type food products because it is baked on demand. Bread wastage can be as high as 30% in some bakeries. Reducing this percentage to zero will make any bakery or other retail establishment more profitable. The systems are easy to use and do not require highly skilled labor, resulting in lower costs to the owners and higher profitability. Unlike the traditional bakeries, future owners of these systems will need less capital to start baking and selling bread on demand, as these systems require a much smaller investment in baking equipment. Instead of requiring “bake from scratch” equipment, since the dough is already made, all the owners need to purchase, for example, are the storage system, the oven and the packaging machine. This significantly reduces the amount of capital as compared to a regular bakery.

### Baking System

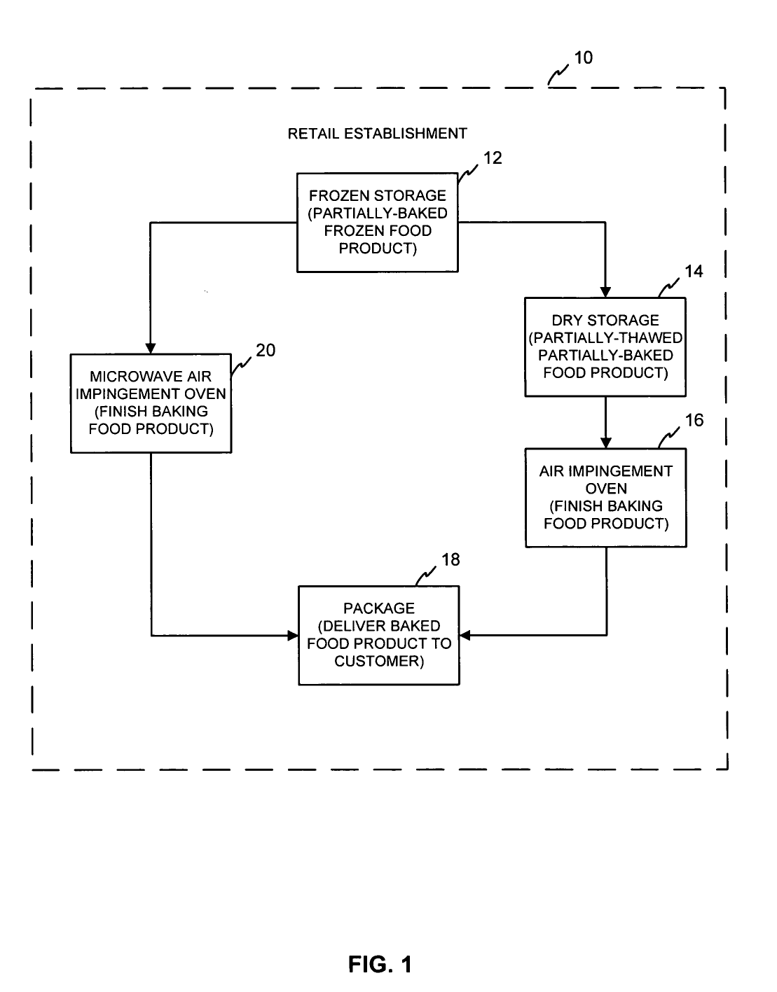

FIG. 1 is a diagram of a baking system for on demand baking of food products. The baking system, or at least a portion of it, is typically contained within a retail establishment 10 providing for the sale of baked food products. For example, retail establishment 10 may include a bakery, grocery store, supermarket, convenience store, restaurant, coffee shop, or other entity providing for the sale of on demand baked food products. The baking system includes a frozen storage 12, at a temperature less than 32° F., to freeze and store partially-baked food products. Frozen storage 12 can be implemented with, for example, a freezer or any element to maintain the partially-baked food products in a frozen state. Before freezing, the food products are partially-baked a particular amount in, for example, a conventional oven at retail establishment 10 or elsewhere. For example, they may be cooked to at least 80% of completion or other amounts.

In one aspect of the baking system, the partially-baked frozen food products are partially thawed in a dry storage 14 such as on racks. Dry storage 14 partially thaws the food products at ambient temperature, for example approximately 70° F., for one hour. When a food product is to be delivered on demand, the partially-thawed food product from dry storage 14 is placed within an air impingement oven 16 and baked at a certain temperature for a particular amount of time to complete baking of it, for example, approximately 450° F. for eight minutes. In an alternative aspect of the baking system, partial thawing is not necessarily required. In this aspect, the partially-baked frozen food product, when it is to be delivered on demand, is placed directly in a microwave air impingement oven 20 and baked at a certain temperature for a particular amount of time to complete baking of it, for example, approximately 425° F. for five minutes, approximately 450° F for four minutes, or approximately 500° F. for three minutes. The baked food product is then optionally packaged 18, such as by wrapping in a breathable material such as a tissue material, and delivered to the customer.

The baking system may include only oven 16 or oven 20, or it may include both ovens. Air impingement oven 16 may be implemented with any oven that provides for baking through the use of heated forced air directed at a food product. Air impingement ovens typically use, but do not necessarily require, a conveyor belt that moves the food product through the oven in a particular amount of time as determined by the speed of the belt. The heated forced air provides for baking and toasting of the food product. The term “air impingement oven” includes any oven capable of simultaneously baking and toasting a food product. An example of an air impingement oven is the MIDDLEBY-MARSHALL oven described in the brochure submitted with the Information Disclosure Statement filed herewith, which is incorporated herein by reference.

Microwave air impingement oven 20 may be implemented with any oven that provides for simultaneous thawing and baking through the use of microwaves and heated forced air directed at a food product. The microwave energy provides for thawing and cooking of the food product, while the heated forced air provides for baking and toasting of the food product. In the microwave air impingement oven, the amount of microwave energy and the temperature of the heated air can be adjusted and varied for optimum thawing, baking, and toasting of a particular type of food product. The term “microwave air impingement oven” includes any oven capable of simultaneously thawing, baking, and toasting a food product. An example of a microwave air impingement oven is the TURBOCHEF C3 oven described in the brochure submitted with the Information Disclosure Statement filed herewith, which is incorporated herein by reference.

The parameters for each stage of the baking system may be obtained through empirical evidence or other ways to obtain the optimum final baked food product. These parameters include, in these embodiments, the amount of partially baking of the food product prior to frozen storage 12, the temperature and amount of partial thawing for dry storage 14, and the temperature and amount of baking time for the food product in ovens 16 and 20. The values for the parameters may depend upon a number of factors such as the particular type of food product to be baked and the type of oven or other equipment used. The values for the parameters as identified above are provided for exemplary purposes only.

### Baking Methods

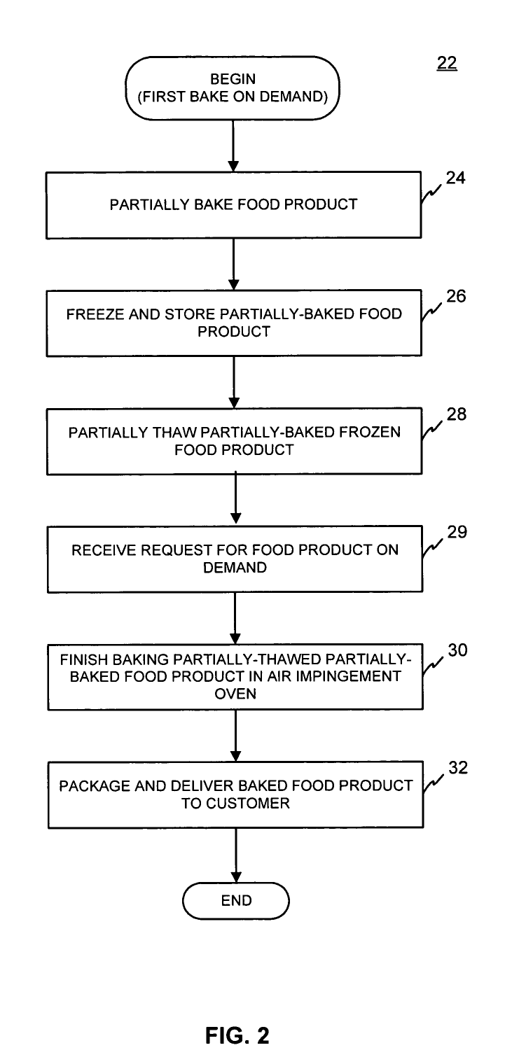

FIG. 2 is a flow chart of a first method 22 for on demand baking using the baking system shown in FIG. 1. In method 22, food products are partially-baked (step 24), which may occur at retail establishment 10 or another entity. The partially-baked food products are frozen and stored in frozen storage 12 (step 26) at retail establishment 10. The partially-baked food products may be partially-baked and frozen at another location, such as a central distribution facility, and then delivered to frozen storage 12. At a particular time, such as prior to the opening of retail establishment 10 for the day, the frozen partially-baked food products are partially thawed in dry storage 14 (step 28). When a customer orders the food product, or when it is otherwise intended to be delivered on demand (step 29), the partially-thawed partially-baked food product is baked in air impingement oven 16 to finish baking of it (step 30). The baked food product can then be optionally packaged, such as in tissue or another kind of wrapper or packaging, and delivered to the customer (step 32).

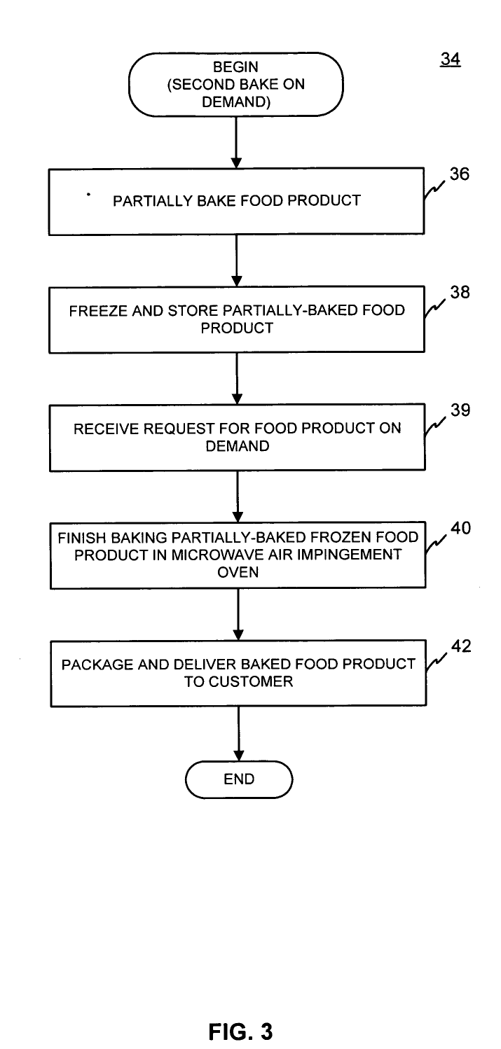

FIG. 3 is a flow chart of a second method 34 for on demand baking using the baking system shown in FIG. 1. In method 34, food products are partially-baked (step 36), which may occur at retail establishment 10 or another entity. The partially-baked food products are frozen and stored in frozen storage 12 (step 38) at retail establishment 10. The partially-baked food products may be partially-baked and frozen at another location, such as a central distribution facility, and then delivered to frozen storage 12. When a customer orders the food product, or when it is otherwise intended to be delivered on demand (step 39), the frozen partially-baked food product is baked in microwave air impingement oven 20 to finish baking of it (step 40). The baked food product can then be optionally packaged, such as in tissue or another kind of wrapper or packaging, and delivered to the customer (step 42). Examples of values for the parameters of the steps in methods 22 and 34 are provided above.

While the present invention has been described in connection with an exemplary embodiment, it will be understood that many modifications will be readily apparent to those skilled in the art, and this application is intended to cover any adaptations or variations thereof. For example, different ovens and amounts of partial cooking of the food products may be used without departing from the scope of the invention. This invention should be limited only by the claims and equivalents thereof.

1. A method of baking a food product, comprising:
partially thaw a partially-baked frozen food product;
placing the partially-thawed partially-baked food product in an air impingement oven and baking the partially-thawed partially-baked food product in the air impingement oven; and
packaging the baked food product.

2. The method of claim 1 wherein the partially thawing step includes thawing the partially-baked frozen food product at approximately 70° Fahrenheit for at least one hour.

3. The method of claim 1 wherein the placing step includes baking the partially-thawed partially-baked food product at approximately 450° Fahrenheit for approximately eight to ten minutes.

4. The method of claim 1 wherein the packaging step includes wrapping the baked food product in a breathable material.

5. The method of claim 4 wherein the wrapping step includes wrapping the baked food product in a tissue material.

6. The method of claim 1, further including using the partially-baked frozen food product being at least 80% baked before being frozen.

7. A method of baking a food product, comprising:
receiving a partially-baked frozen food product;
placing the partially-baked frozen food product in a microwave air impingement oven and baking the partially-baked frozen food product in the microwave air impingement oven; and
packaging the baked food product.

8. The method of claim 7 wherein the placing step includes baking the partially-baked frozen food product at approximately 425° F. for five minutes, approximately 450° F. for four minutes, or approximately 500° F. for three minutes.

9. The method of claim 7 wherein the packaging step includes wrapping the baked food product in a breathable material.

10. The method of claim 9 wherein the wrapping step includes wrapping the baked food product in a tissue material.

11. The method of claim 7, further including using the partially-baked frozen food product being at least 80% baked before being frozen.

12. A baking system for baking on demand food products, comprising:
a frozen storage for maintaining a partially-baked food product in frozen state;
a dry storage for partially thawing the partially-baked food product;
an air impingement oven for baking the partially-thawed partially-baked food product; and
a packaging for delivering the baked food product.

13. The system of claim 12 wherein the air impingement oven is configured to finish baking of the partially-thawed partially-baked food product at approximately 450° Fahrenheit for approximately eight to ten minutes.

14. The system of claim 12 wherein the packaging includes a tissue material.

15. A baking system for baking on demand food products, comprising:
a frozen storage for maintaining a partially-baked food product in frozen state;
a microwave air impingement oven for baking the frozen partially-baked food product; and
a packaging for delivering the baked food product.

16. The system of claim 15 wherein the microwave air impingement oven is configured to finish baking of the frozen partially-baked food product at approximately 425° F. for five minutes, approximately 450° F. for four minutes, or approximately 500° F. for three minutes.

17. The system of claim 15 wherein the packaging includes a tissue material.

18. A method of baking a food product, comprising:
receiving a partially-baked frozen food product, the food product being baked to at least 80% of completion before freezing;
placing the partially-baked frozen food product in a microwave air impingement oven and baking the partially-baked frozen food product in the microwave air impingement oven at a temperature sufficient to complete baking of the partially-frozen food product in five minutes or less; and
delivering the baked food product.

19. The method of claim 18 wherein the placing step includes baking the partially-frozen food product at approximately 425° F. for five minutes, approximately 450° F. for four minutes, or approximately 500° F. for three minutes.

20. The method of claim 18 wherein the delivering step includes providing, using the receiving and placing steps, baked bread for a customer while the customer waits during the five minutes or less baking.
